(19) United States
(12) Patent Application Publication
(10) Pub. No.: US 2013/0326038 A1
(43) Pub. Date: Dec. 5, 2013

(54) MANAGEMENT OF DATACENTERS FOR FAULT TOLERANCE AND BANDWIDTH

(71) Applicants: Peter Bodik, Kirkland, WA (US); Ishai Menache, Redmond, WA (US); Peter Winkler, Hanover, NH (US); Gregory M. Foxman, Seattle, WA (US); N. M. Mosharaf Kabir Chowdhury, Berkeley, CA (US)

(72) Inventors: Peter Bodik, Kirkland, WA (US); Ishai Menache, Redmond, WA (US); Peter Winkler, Hanover, NH (US); Gregory M. Foxman, Seattle, WA (US); N. M. Mosharaf Kabir Chowdhury, Berkeley, CA (US)

(73) Assignee: Microsoft Corporation, Redmond, WA (US)

(21) Appl. No.: 13/489,207

(22) Filed: Jun. 5, 2012

(51) Int. Cl. G06F 15/173

(52) U.S. Cl. 709/223

(57) ABSTRACT

Upon receiving a request to improve one or more conditions of a datacenter network, a fault management system may analyze information of the datacenter network including communication patterns among services provided in the network. The fault management system determines one or more logical machines associated with one or more services to be moved from one or more devices to one or more other devices of the network. The fault management system may select these one or more logical machines for migration based on a cost function including factors for fault tolerance, bandwidth usage, number of moves and/or response time latency. The fault management system may improve the fault tolerance of the network without significantly affecting the bandwidth usage of the network.

### BACKGROUND

Increasing numbers of users rely on online services to manage and process computation, storage and communication nowadays. In view of this increasing demand from the users, datacenter networks have been developed to provide various services that are accessible to the users. Furthermore, with a view to minimizing impacts on the users in case of failures in the networks, these datacenter networks have been designed to tolerate failure of network devices and provide bandwidth that is sufficient for use by the network devices. In practice, however, the failures and maintenance of network devices and power devices in the datacenter networks can often cause an unavailability of a tremendous number of servers and unavoidably incur a service latency of the online services to the users. Also, there exists an inherent tradeoff between achieving high fault tolerance and reducing bandwidth usage in the networks—spreading services across fault domains improve fault tolerance but requires additional bandwidth, while deploying services together reduces bandwidth usage but decreases fault tolerance.

Although additional devices may be added to the datacenter networks to provide alternative and/or redundant paths between network devices, which possibly improve survival opportunity of the online services in case of a network or power failure, this strategy raises another operating issue—an increase in operating and maintenance costs of the datacenter networks.

### SUMMARY

This summary introduces simplified concepts of fault tolerance management, which are further described below in the Detailed Description. This summary is not intended to identify essential features of the claimed subject matter, nor is it intended for use in limiting the scope of the claimed subject matter.

This application describes example embodiments of fault tolerance management. In one embodiment, information of a network of devices may be received. The received information of the network of devices may include, for example, information of one or more fault domains that each device may belong to. In one embodiment, the network of devices may be divided into a plurality of cells based on the received information, where each cell may include one or more devices of the network that belong to one or more same fault domains. In some embodiments, the one or more devices in each cell may be indistinguishable from each other in view of a fault associated with the one or more same fault domains. In one embodiment, each cell may further include one or more logical machines deployed in the one or more devices therein.

In some embodiments, a logical machine may be determined to be migrated from one cell to another cell to improve one or more conditions associated with the network or a service supported by the logical machine based on a cost function. In one embodiment, the one or more conditions may include fault tolerance associated with a service provided in the network of devices, a bandwidth usage associated with the service, a response latency associated with the service, etc. In one embodiment, the cost function may include a plurality of factors including a factor for fault tolerance associated with the service supported by the logical machine, a factor for bandwidth usage associated with the service, and/or a factor for a number of migrations for logical machines. Upon determining which logical machine to be migrated, the determined logical machine may be migrated from one cell to the other cell according to a migration plan.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1A illustrates an example environment including an example fault management system.

FIG. 1B illustrates an example change in configuration of logical machines in a network due to services migration suggested by the example fault management system of FIG. 1.

FIG. 2 illustrates the example fault management system of FIG. 1 in more detail.

FIG. 3 illustrates an example communication pattern between services that are deployed in a network of devices.

FIG. 4 illustrates example sizes of connected components in an example service communication graph for different fractions of traffic that is considered in FIG. 3.

FIG. 5 illustrates an example method of improving one or more conditions of a network of devices.

### DETAILED DESCRIPTION

### Overview

As noted above, existing datacenter networks, though originally designed for tolerating failures due to network and/or power devices, often fail to maintain an adequate degree of availability of services to users in face of a failure in the networks. Further, as new services are added and outdated services are removed, a landscape or pattern of communications among services in the network dynamically changes. The existing datacenter networks fall short of providing an algorithm or plan to revise allocation of the services in the networks to adapt to this new landscape or pattern of communications.

This disclosure describes a fault management system, which improves fault tolerance of services provided in a network of devices with a given topology without increasing bandwidth usage associated with the network. Additionally or alternatively, the fault management system may reduce the bandwidth usage without deteriorating the fault tolerance. Additionally or alternatively, the fault management system may improve both the bandwidth usage and the fault tolerance at the same time. The fault management system may attain to improve one or more conditions (such as fault tolerance, bandwidth usage, response latency, etc.) associated with the network based on a request from a user or administrator of the network.

In one embodiment, fault tolerance may be measured using a worst-case survival, which may be defined as a percentage or fraction of devices of a service that remain available during a single, worst-case failure. In one embodiment, a worst-case survival (WCS) associated with a single, worst-case failure may be defined as the smallest fraction of devices that remain functional during a single failure in the datacenter network. In one embodiment, a service may include a service or application deployed in a single device or a service or application distributed among a plurality of devices. In the latter case, the distributed service or application may include a number of logical machines which are deployed in the plurality of devices. Each logical machine may represent a minimal logical component of that distributed service or application. By way of example and not limitation, the logical machines for a particular service may be the same programs or codes running or deployed on a plurality of devices. In one embodiment, a device may include at most or at least one logical machine. Although the fault management system in the following description is described to consider one or more logical machines (parts of one or more services) for migrating from one or more devices to one or more other devices in a network, in some embodiments, the fault management system may consider migrating one or more services from one or more devices to one or more other devices of the network.

Generally, the fault management system may receive information about a topology of a network of devices that provide a plurality of services. In one embodiment, in response to receiving the topology information, the fault management system may analyze patterns of communication among the plurality of services over a certain period of time. For example, the fault management system may determine bandwidth usage associated with each service and/or each pair of services of the plurality of services. Additionally or alternatively, the fault management system may determine distribution of the plurality of services among the devices of the network. For example, the fault management system may determine how logical machines that provide and/or support the same and/or related functions for a service are distributed across the network.

In one embodiment, based on the determined bandwidth usage and/or distribution of the plurality of services, the fault management system may determine which one or more logical machines may be migrated to enhance fault tolerance of one or more services (that are associated with the one or more logical machines) with or without increasing total bandwidth usage of the network or overloading any particular communication path between two devices of the network. In one embodiment, the fault management system may explore skewness of the communication patterns of the network. By way of example and not limitation, the fault management system may determine that a substantially greater portion or percentage of the bandwidth usage and/or inter-service (or inter-device) communications associated with the network is used by a first number of services. Additionally or alternatively, the fault management system may determine that a second number of services attribute little or no bandwidth usage and/or inter-service (or inter-device) communications in the network. In some embodiments, the fault management system may analyze distribution of the first number of services and/or the second number of services across the network or a portion of the network.

In one embodiment, based on knowledge of the first number of services and/or the second number of services, the fault management system may select one or more logical machines that are associated with the services to migrate from one device to another device of the network to increase fault tolerance and reduce bandwidth usage of the network. For example, the fault management system may migrate one or more logical machines from one or more devices to one or more other devices to spread out the logical machines that provide the same service over the network or across domains vulnerable to different sources of fault failures. This reduces a likelihood of causing an unavailability of the service due to a failure in part of the network, thus improving fault tolerance of the service. In addition, the fault management system may migrate one or more logical machines of one or more services from one or more devices to one or more other devices to cluster services that communicate with each other frequently and/or services that use a relatively high data bandwidth of the network together, thus reducing bandwidth usage of the network.

Thus, the fault management system may migrate one or more logical machines from one or more devices to one or more other devices to spread out the logical machines that provide or support the same service over the network or across fault domains while also clustering services that communicate with each other frequently and/or use a relatively high data bandwidth of the network together, thereby simultaneously improving the fault tolerance of the services and reducing the bandwidth usage of the services.

In some embodiments, the fault management system may further limit a number of moves for service migration. In one embodiment, the number of moves may be defined as, for example, the number of logical machines to be moved or migrated. In some embodiments, the number of moves may be defined as an amount of data transfer for accomplishing the service migration. In addition, the fault management system may receive a request, for example, from an administrator of the network indicating a maximal number of moves allowed for the service migration in the network. Additionally or alternatively, the fault management system may receive a request from the administrator of the network specifying which one or more services and/or one or more devices of the network need to be considered in the service migration, because of, for example, a scheduled maintenance of the one or more services and/or the one or more devices in the network.

In one embodiment, the fault management system may employ an optimization algorithm to select the one or more logical machines to be migrated, and apply the optimization algorithm through an objective or cost function that may include factors such as fault tolerance, bandwidth usage, number of moves, one or more specific services and/or devices, etc. In some embodiments, prior to applying the optimization algorithm, the fault management system may select a number of logical machines as candidate logical machines for consideration in service migration based on a predetermined strategy. In one embodiment, the predetermined strategy may include, for example, randomly selecting a number of logical machines from the network, selecting a number of logical machines that are located in one or more particular fault domains or geographical locations, and/or selecting a number of logical machines that provide and/or support functions for one or more particular services in the network, etc. In response to selecting candidate logical machines for consideration in service migration, in one embodiment, the fault management system may determine or select one or more logical machines from these candidate logical machines that may optimize the objective or cost function based on the optimization algorithm. For example, the fault management system may select one or more logical machines from the candidate logical machines that return the first few (or a predetermined number) lowest values of the objective or cost function. In one embodiment, the optimization algorithm may include, but is not limited to, a greedy algorithm, an integer programming algorithm, a gradient descent algorithm, and/or simulated annealing algorithm.

In one embodiment, upon selecting one or more logical machines for service migration, the fault management system may send information of the one or more selected logical machines (and/or affected services) to an administrator of the network and allow the administrator to perform the service migration using other systems. In some embodiments, the fault management system may migrate the one or more selected logical machines from one or more devices to one or more other devices on behalf of the administrator automatically or upon approval. In one embodiment, the fault management system may further develop a plan of service migration, e.g., an order of migration of the one or more logical machines. The fault management system may submit the plan or a relevant portion of the plan to relevant devices (e.g., devices from which and to which the one or more selected logical machines are migrated), and coordinate the relevant devices to perform the migration of the one or more selected logical machines. In one embodiment, the fault management system may send a notification of successful migration to the administrator of the network upon the completion of the migration of the one or more selected logical machines.

The described system allows analyzing bandwidth usage and distribution of services offered by a network of devices that has a particular topology. Upon obtaining an analysis result of the bandwidth usage and the distribution of the services, the system may suggest a number of logical machines that provide or support functions for one or more services to migrate from one device(s) to another device(s) to improve fault tolerance and/or bandwidth usage of the one or more services in the network. The system may further devise a plan of how the suggested logical machines are to be migrated in series and/or in parallel from one device(s) to another device(s), and coordinate execution of the plan in relevant devices. In doing so, the described system may minimize the number of moves involved in the service migration.

While in the examples described herein, the fault management system analyzes distribution and communication information related to services that are provided by a network of devices, determines one or more logical machines that may be migrated, devises a plan of service migration, and coordinates the service migration, in other embodiments, these functions may be performed by multiple separate systems or services. For example, in one embodiment, an analysis service may analyze distribution and communication information related to services, while a separate service may determine one or more logical machines to be migrated, and yet another service may devise a plan of service migration, and coordinate the service migration.

The application describes multiple and varied implementations and embodiments. The following section describes an example environment that is suitable for practicing various implementations. Next, the application describes example systems, devices, and processes for implementing a fault management system.

### Exemplary Environment

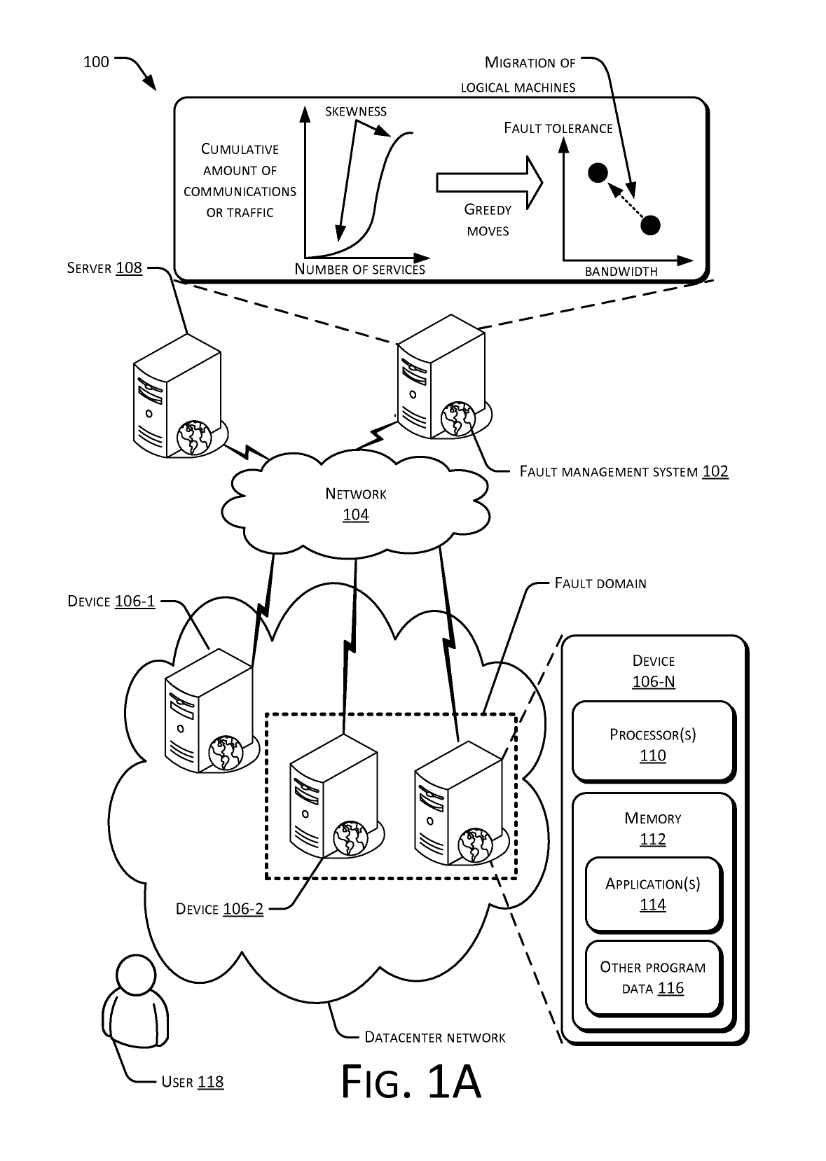

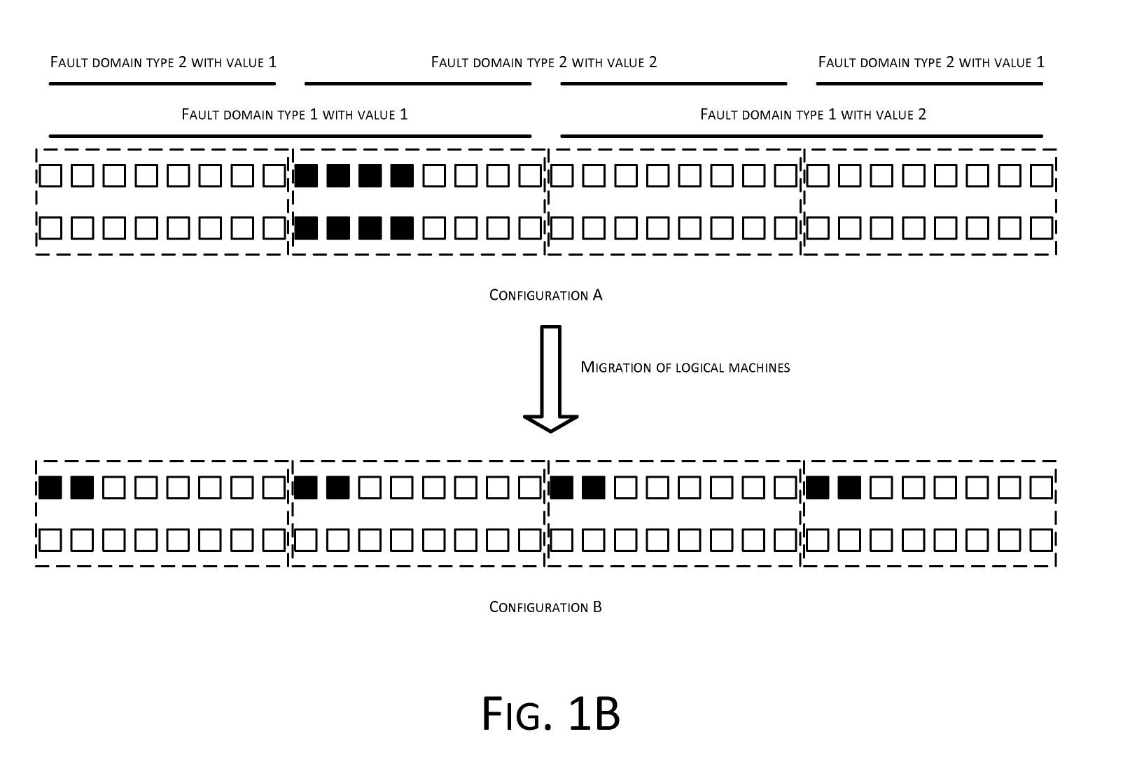

FIG. 1A illustrates an exemplary environment 100 usable to implement a fault management system 102. In some embodiments, the environment 100 may include a network 104 and a plurality of servers or devices 106-1, 106-2, . . . , 106-N (collectively referred to as device 106). The plurality of devices 106 may communicate data with each other and the fault management system 102 via the network 104. In one embodiment, the plurality of devices 106 may form a datacenter network, e.g., a large-scale datacenter network.

Although the fault management system 102 is described to be separate from the plurality of devices 106, in some embodiments, functions of the fault management system 102 may be included and distributed among one or more devices 106. For example, one of the devices 106 may include part of the functions of the fault management system 102 while other functions of the fault management system 102 may be included in one or more other devices 106. Furthermore, in some embodiments, the fault management system 102 may be included in a third-party server, e.g., other server 108, that may or may not be affiliated with the datacenter network.

The device 106-N, representative of the devices 106, may be implemented as any of a variety of conventional computing devices including, for example, a mainframe computer, a server, a notebook or portable computer, a handheld device, a netbook, an Internet appliance, a tablet or slate computer, a mobile device (e.g., a mobile phone, a personal digital assistant, a smart phone, etc.), etc. or a combination thereof.

The network 104 may be a wireless or a wired network, or a combination thereof. The network 104 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

In one embodiment, the device 106 includes one or more processors 110 coupled to memory 112. The memory 112 includes one or more applications or services 114 (e.g., web applications or services, storage applications or services, etc.) and other program data 116. The memory 112 may be coupled to, associated with, and/or accessible to other devices, such as network servers, routers, and/or the devices 106.

A user 118 (e.g., an administrator or personnel of the datacenter network) may send a request to trigger the fault management system 102 to analyze the datacenter network. In one embodiment, based on an analysis result of the datacenter network, the fault management system 102 may determine whether fault tolerance and/or bandwidth usage of one or more services in the datacenter network may be improved by moving one or more logical machines (that are associated with the one or more services) from one or more devices 106 to one or more other devices 106.

Additionally or alternatively, the fault management system 102 may be triggered to perform the above determination(s) on a regular basis. Additionally or alternatively, the fault management system 102 may be triggered to perform the above determination(s) in response to occurrence of a predetermined event (e.g., addition of a threshold number of new services, addition of threshold number of new hardware devices, removal of services or devices, etc.). Additionally or alternatively, the fault management system 102 may be triggered to perform the above determination(s) in response to determining that a scheduled maintenance and/or shutdown of part or all of the datacenter network will begin after a predetermined amount of time later, e.g., one day later, one week later, one month later, etc. Additionally or alternatively, the fault management system 102 may be triggered to perform the above determination(s) in response to detecting abnormally frequent or skewed communications or communication patterns between certain services provided in the datacenter network.

Regardless of how the fault management system 102 is triggered, the fault management system 102 may analyze the datacenter network and determine which one or more logical machines that, when migrated, will improve the fault tolerance and/or bandwidth usage of one or more services in the datacenter network. Upon determining which one or more logical machines to be migrated, the fault management system 102 may send a plan of service migration to the user 118 for approval and/or coordinate migration of the one or more determined logical machines across relevant devices 106 of the datacenter network. In one embodiment, upon receiving an approval from the user 118, the fault management system 102 may monitor or coordinate the migration of the one or more logical machines. FIG. 1B illustrates example configurations of logical machines deployed in the network before and after the service migration. In FIG. 1B, the full blocks represent devices in which the one or more logical machines involved in the service migration are located before and after the service migration.

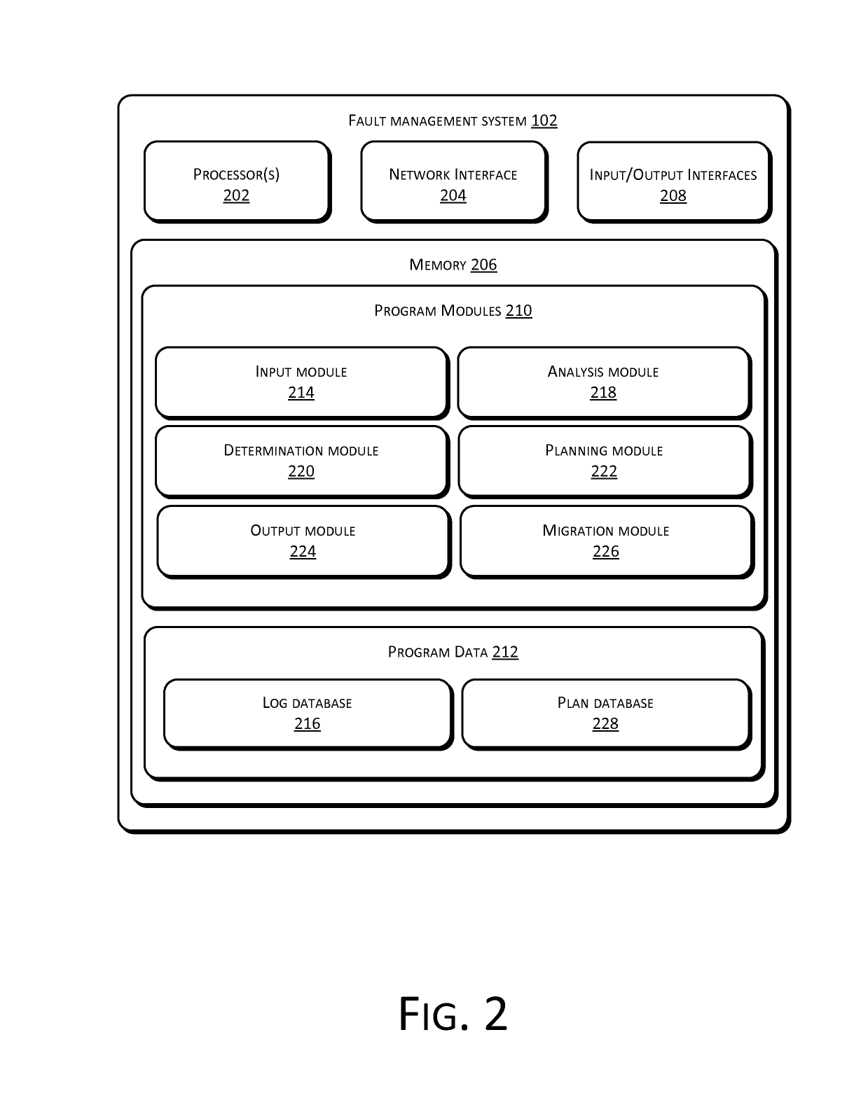

FIG. 2 illustrates the fault management system 102 in more detail. In one embodiment, the fault management system 102 includes, but is not limited to, one or more processors 202, a network interface 204, memory 206, and an input/output interface 208. The processor(s) 202 is configured to execute instructions received from the network interface 204, received from the input/output interface 208, and/or stored in the memory 206.

The memory 206 may include computer-readable media in the form of volatile memory, such as Random Access Memory (RAM) and/or non-volatile memory, such as read only memory (ROM) or flash RAM. The memory 206 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The memory 206 may include program modules 210 and program data 212. In one embodiment, the fault management system 102 may include an input module 214. The input module 214 may receive an instruction or request to analyze and/or improve one or more conditions of the datacenter network from an administrator or personnel of the datacenter network. The one or more conditions of the datacenter network may include, but are not limited to, fault tolerance and bandwidth usage associated with part or all of the services or devices in the datacenter network, etc. In some embodiments, the one or more conditions of the datacenter network may further include, for example, time or response latency associated with part or all of the services in the datacenter network to respond one or more job requests from one or more users, etc.

In one embodiment, the instruction or request may include, but is not limited to, an identity of the datacenter network, a time and/or date before which the instruction or request is requested to be completed, and/or a frequency of executing the instruction or request (e.g., every week, every month, etc.), etc. In some embodiments, the instruction or request may further include, for example, one or more criteria or constraints for improving the one or more conditions of the datacenter network. By way of example and not limitation, the one or more criteria or constraints may include, for example, a maximum number of moves of services that are permitted to achieve the improvements, a minimum extent that the one or more conditions (e.g., a minimum percentage of improvement in fault tolerance, for example) need to be improved, an acceptable range of fault tolerance, an acceptable range of bandwidth usage, a maximum amount of data transfer allowed for migration, etc.

In one embodiment, the input module 214 may further obtain information related to the datacenter network from a log database 216 of the fault management system 102. The log database 216 of the fault management system 102 may collect the information related to the datacenter network on a regular basis and/or upon request, for example, by the administrator of the datacenter network and/or the user 118 of the fault management system 102. Additionally or alternatively, the input module 214 may obtain the information related to the datacenter network from one or more devices of the datacenter network. Additionally or alternatively, the input module 214 may obtain the information related to the datacenter network from a third-party database or a database affiliated with the datacenter network. In one embodiment, the information related to the datacenter network may include, but is not limited to, information about distribution and/or bandwidth usages (or communications) of part or all of the plurality of services that are deployed in the devices within the datacenter network.

In some embodiments, each device of the datacenter network may collect or log information of which service is deployed in which respective device(s), an amount of data that has been sent and/or received for each deployed service, and/or with which service each deployed service has communicated, etc. In one embodiment, each device of the datacenter network may further report part or all of this collected or logged information to the input module 214, the log database 216, the third-party database and/or the affiliated database, etc in a plain or organized form. For example, a device of the datacenter network may report information of a predetermined number or percentage of respective deployed services that, among deployed services in that device, have consumed most of the bandwidth of the datacenter network and/or have communicated with other devices or services in other devices most frequently over a predetermined period of time. A value of the predetermined number or percentage may be set up in advance by the user 118 or the administrator of the datacenter network, or could be a default setting.

Additionally or alternatively, one or more devices of the datacenter network and/or a third-party server (e.g., the other server 108) may receive and/or process part or all of the collected or logged information from each device as described above. In one embodiment, the one or more devices of the datacenter network and/or the third-party server may determine bandwidth usages of each service and each pair of services provided in the datacenter network. Additionally or alternatively, the one or more devices of the datacenter network and/or the third-party server may determine a predetermined number or percentage of services that, among all services provided in the datacenter network, have consumed most of the bandwidth of the datacenter network and/or have communicated with other devices or services in other devices most frequently over a predetermined period of time.

Additionally or alternatively, the one or more devices of the datacenter network and/or the third-party server may determine distribution of logical machines providing and/or supporting functions for a same service of the plurality of services provided in the datacenter network based on knowledge of a topology of the datacenter network, for example. Additionally or alternatively, the one or more devices of the datacenter network and/or the third-party server may determine respective densities of logical machines that provide and/or support functions for the same service in the datacenter network based on, for example, knowledge of the topology of the datacenter network. Additionally or alternatively, the one or more devices of the datacenter network and/or the third-party server may determine a predetermined number of logical machines (each providing and/or supporting functions for a same service) that are most densely located together in the datacenter network. Additionally or alternatively, the one or more devices of the datacenter network and/or the third-party server may determine in which one or more devices of the datacenter network these most densely located logical machines are deployed or located. In some embodiments, the one or more devices of the datacenter network and/or the third-party server may determine or include information of failure rates associated with one or more points of network failures (e.g., a top-of-rack (TOR) switch, a circuit breaker, an aggregation switch or router, etc.). Additionally or alternatively, the one or more devices of the datacenter network and/or the third-party server may determine or include information of failure rates associated with one or more points of power failures (such as a point of wiring, power supply or source, etc.).

In one embodiment, the fault management system 102 may further include an analysis module 218 to analyze the information related to the datacenter network. Depending on whether the information related to the datacenter network that is received by the input module 214 has previously been processed as described in the foregoing embodiments, the analysis module 218 may process the raw information (i.e., the information that has been collected or logged by each device and has not been processed by respective devices and/or other devices or servers as described in the foregoing embodiments). In one embodiment, the analysis module 218 may process the information related to the datacenter network as described above with respect to each device, the one or more devices and/or the third-party server in the foregoing embodiments.

Regardless of whether the information related to the datacenter network has been processed, the analysis module 218 may examine the information to determine communication patterns among the services of the datacenter network. In one embodiment, the analysis module 218 may determine or detect skewness associated with the communications patterns among the services of the datacenter network.

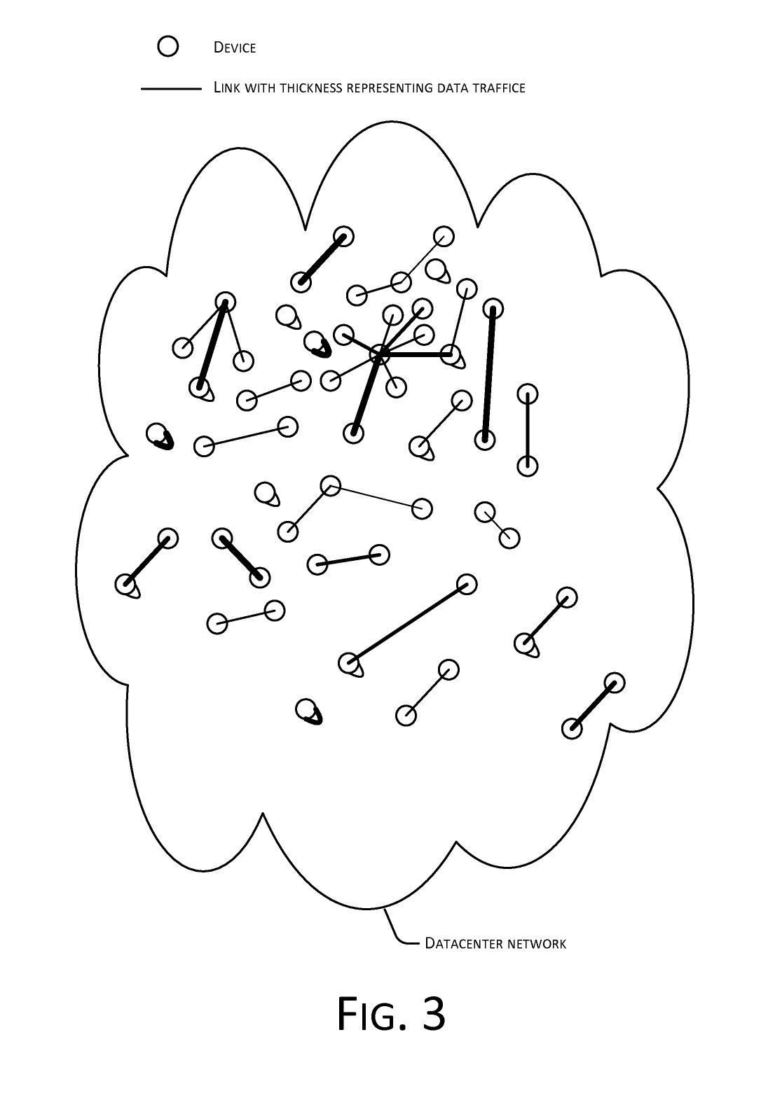

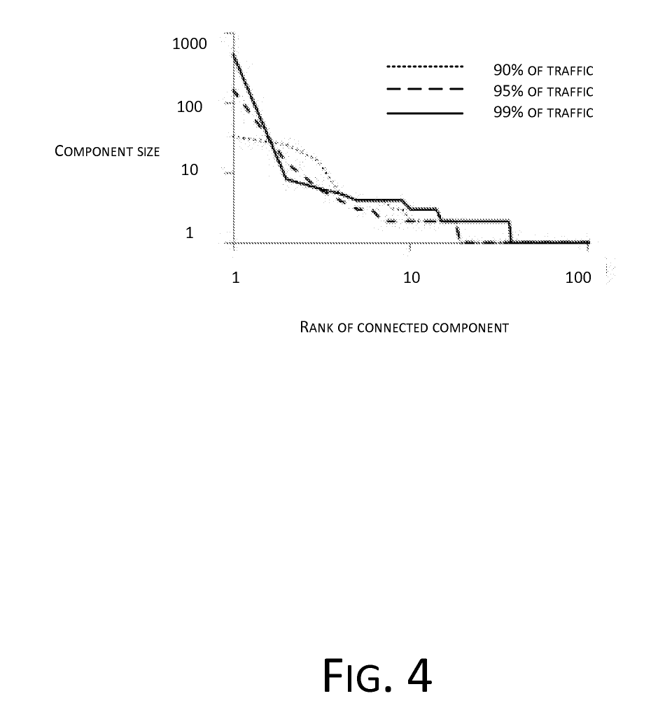

By way of example and not limitation, the analysis module 218 may analyze the information related to the datacenter network, and determine that the communication patterns among the services are skewed, having most of the inter-service and/or inter-device communications (or most of the total bandwidth usage of the datacenter network) are attributed by a small number of services while most of the services attribute little or no inter-service and/or inter-device communications (or most of the total bandwidth usage of the datacenter network) within the datacenter network. For example, the analysis module 218 may examine the communications among the services and determine which one or more services attribute most of the communications or data traffic (e.g., 90% of the traffic) in the datacenter network as shown in FIG. 3. FIG. 4 illustrates example sizes of connected components in an example service communication graph for different fractions of traffic that is considered in FIG. 3.

Additionally or alternatively, the analysis module 218 may further analyze distribution of the services in the datacenter network. For example, the analysis module 218 may determine how logical machines that provide and/or support functions for a service are distributed across the datacenter network, and which areas or groups of nearby devices in the datacenter network these logical machines are clustered together. The analysis module 218 may perform these determinations based on, for example, the known topology of the datacenter network.

In one embodiment, the analysis module 218 may further divide the devices, the services or the logical machines based on points of failure in the datacenter network. A point of failure may include, but is not limited to, hardware or software in the datacenter network that, when failed, causes one or more devices, services or logical machines connected to that hardware or software to become unavailable or reduced in the capability to serve users of the one or more devices or services. By way of example and not limitation, a point of failure may include, for example, a top-of-rack (TOR) switch, a same circuit breaker, an aggregation switch or router, a same server container, a same server enclosure, etc. Additionally or alternatively, the point of failure may include, but is not limited to, a same power domain such as a power failure due to a same or common point of wiring, power supply or source to one or more devices of the datacenter network.

In one embodiment, the analysis module 218 may divide the devices or the services into a plurality of cells based on the topology of the network. In one embodiment, a cell includes, for example, a number of devices or logical machines that belong to one or more same fault domains. Additionally or alternatively, the analysis module 218 may partition the devices or the logical machines into a plurality of cells with each device or logical machine belonging to exactly one cell (i.e., the cells do not overlap with one another). In one embodiment, a fault domain may be defined as one or more devices or services that share a single point of failure such as a TOR switch, a same circuit breaker, for example. Additionally, the one or more devices that belong to the same fault domains may be considered as indistinguishable in face of a fault (e.g., the shared single point of failure) that is shared by the one or more devices as shown in FIG. 1A, for example.

In some embodiments, the fault management system 102 may further include a determination module 220. If the instruction or request received by the input module 214 includes an instruction or request of improving one or more conditions (e.g., fault tolerance, bandwidth usage, response or time latency etc.) of the datacenter network, the determination module 220 may determine which one or more logical machines may be moved or migrated within the datacenter network to improve the one or more conditions associated with the datacenter network. In one embodiment, the determination module 220 may determine which one or more logical machines may be moved based on an analysis result of the analysis module 218. By way of example and not limitation, the determination module 220 may select one or more logical machines to move from one or more devices or cells to one or more other devices or cells of the datacenter network based on the analysis result and/or information of the topology of the datacenter network that is accessible to the determination module 220.

Additionally or alternatively, if the plurality of devices in the datacenter network have been partitioned into a plurality of cells, the determination module 220 may determine which one or more cells may be involved in the service migration based on the analysis result of the analysis module 218. In one embodiment, the determination module 220 may randomly select one or more logical machines within each cell to be moved. In some embodiments, the determination module 220 may select one or more logical machines that engage in the least amount of communications or bandwidth usage with other services in the same cell and/or nearby cells to be moved. Additionally or alternatively, the determination module 220 may select a logical machine that has other logical machines providing and/or supporting the same service within the same cell to be moved to increase fault tolerance, for example.

In one embodiment, the determination module 220 may employ an optimization algorithm to determine which one or more logical machines may be migrated within the datacenter network. An optimization algorithm may include, for example, a greedy algorithm, an integer programming algorithm, a gradient descent algorithm, a simulated annealing, a combination thereof, and other conventional optimization algorithms suitable for this purpose. An example of an optimization algorithm will be described hereinafter. Additionally or alternatively, in one embodiment, the determination module 220 may develop an objective or cost function that includes one or more terms or factors associated with the one or more conditions of the datacenter network that are to be improved. Examples of the one or more terms or factors to be included in the objective or cost function may include, but are not limited to, fault tolerance, bandwidth usage, response or time latency, and/or number of moves, etc. Additionally, in some embodiments, the one or more terms or factors to be included in the objective or cost function may include failure rates of one or more points of network failures and/or one or more points of power failures.

In some embodiments, the determination module 220 may further impose one or more constraints on the objective or cost function, and optimize the objective or cost function under the one or more constraints using an optimization algorithm. In one embodiment, the one or more constraints may include, for example, fault tolerance, bandwidth usage, response or time latency, and/or number of moves, etc., that is/are not used as term(s) or factor(s) in the objective or cost function. Additionally or alternatively, in some embodiments, the one or more constraints may include a maximum amount of data transfer (e.g., when migrating one or more services from one device to another device) that is allowed for migration.

Depending on which one or more conditions of the datacenter network the instruction or request intends to improve, the determination module 220 may select different logical machines (for different conditions requested to be improved) based on, for example, applying an optimization algorithm through an objective or cost function as described above. Detailed description of exemplary implementations using an optimization algorithm to determine one or more logical machines for migration may be found in Exemplary Implementation section hereinafter.

Additionally or alternatively, the fault management system 102 may select a subset (less than all) of logical machines included in the network of devices as candidate logical machines for consideration in service migration based on a predetermined strategy. In one embodiment, the predetermined strategy may include, for example, randomly selecting a number of logical machines from the network, selecting a number of logical machines that are located in one or more particular fault domains or geographical locations, and/or selecting a number of logical machines that provide and/or support functions for one or more particular services in the network, etc. In response to selecting candidate logical machines for consideration in service migration, in one embodiment, the fault management system 102 may determine or select one or more logical machines from these candidate logical machines that may optimize the objective or cost function based on the optimization algorithm. For example, the fault management system 102 may select one or more logical machines from the candidate logical machines that return the first few (or a predetermined number) lowest values of the objective or cost function.

Additionally or alternatively, in some embodiments, the determination module 220 may employ one or more heuristic strategies to select logical machines for migration. By way of example and not limitation, the determination module 220 may select logical machines of one or more pairs of services that communicate most frequently (e.g., top one, three or ten frequently communicated services) and/or utilize the bandwidth of the datacenter network the most (e.g., top one, three or ten bandwidth-usage services) for migration to reduce bandwidth usage of the datacenter network. In one embodiment, the determination module 220 may determine to move or migrate one or more logical machines of a service of a pair of services to the same device including one or more logical machines of the other service of the pair. In some embodiments, the determination module 220 may determine to move or migrate one or more logical machines of a service of a pair of services to a device that is communicatively closer to a device including one or more logical machines of the other service of the pair than before. Additionally or alternatively, the devices of these services of the pair may belong to one or more same or different fault domains.

Additionally or alternatively, the determination module 220 may determine that logical machines that provide and/or support a same service are densely clustered together in a same fault domain. The determination module 220 may determine or suggest to migrate one or more of these determined logical machines to one or more devices that belong to one or more fault domains different from their original fault domain, thereby increasing fault tolerance of the service. Additionally or alternatively, the determination module 220 may select one or more services to be migrated that would involve the least amount of data transfer for the migration.

In some embodiments, upon determining or selecting one or more logical machines to be migrated, the fault management system 102 may devise a plan of how to migrate the one or more logical machines. In one embodiment, the fault management system 102 may include a planning module 222 that devises the plan of migration for the one or more logical machines. By way of example and not limitation, the planning module 222 may determine whether the one or more logical machines include logical machines that provide and/or support a same service. In an event of detecting the one or more logical machines including logical machines that provide and/or support the same service, the planning module 222 may determine whether a number or percentage (i.e., a percentage compared to a total number of logical machines associated with the same service in the datacenter network) of these logical machines is greater than or equal to a predetermined threshold. If the number or percentage of these logical machines providing and/or supporting the same service is greater than or equal to the predetermined threshold, the planning module 222 may devise a plan that may migrate these logical machines at different times to avoid unavailability of a large number or percentage of these logical machines (and hence the service) to the users thereof due to migration of these logical machines. In some embodiments, if the number or percentage of these logical machines is less than the predetermined threshold, the planning module 222 may devise a plan that may allow these logical machines to be migrated at the same time, i.e., in parallel.

Additionally or alternatively, the planning module 222 may analyze usage of or access to services associated with the one or more logical machines to be migrated over a predetermined time period, e.g., a day, a week, a month, etc., based on the information received by the input module 214 or the information analyzed by the analysis module 218, for example. The planning module 222 may determine an expected time of minimal usage or access of a service by analyzing the historical usage or access to the service over the predetermined time period. For example, the planning module 222 may determine that a service usually has a minimal usage or access, e.g., at 3 am every day. In one embodiment, the planning module 222 may devise a plan that may migrate each logical machine (that is associated with the service) from one device to another device of the datacenter network during the corresponding expected time of minimal usage or access. Additionally or alternatively, the planning module 222 may select a time (e.g., corresponding expected time of minimal usage or access) for migrating a logical machine of the one or more logical machines that is prior to a requested time of completed migration if this requested time is included in the received instruction or request.

Additionally or alternatively, the planning module 222 may determine whether the one or more logical machines to be migrated include logical machines that are associated with services that communicate with each other frequently (e.g., a frequency of communication is greater than or equal to a predetermined threshold). In an event of detecting the one or more logical machines including logical machines providing and/or supporting services that communicate with each other frequently, the planning module 222 may devise a plan that may migrate these logical machines of frequently communicated services in parallel or substantially at the same time. This avoids causing a longer time of interruption for communications among these services if these associated logical machines are migrated in series or at different times.

In one embodiment, in response to devising a plan of migration of the one or more logical machines, the planning module 222 may send a message including the plan to the administrator of the datacenter network through an output module 224. In some embodiments, the output module 224 may further send an expected amount of improvement (e.g., percentage of fault tolerance, bandwidth usage, response time latency, etc., expected to be improved by migrating the one or more logical machines) determined by the determination module 220 to the administrator. In some embodiments, the devised plan may include an identifier that (uniquely) identifies the plan itself. The output module 224 may send this identifier of the plan explicitly or implicitly with the message. Upon receiving the plan, the administrator of the datacenter network, if agreeing with the plan, may instruct one or more devices of the datacenter network or another system to execute the migration plan.

In some embodiments, the fault management system 102 may be responsible for executing and/or monitoring the migration. In this latter case, the output module 224 may send the plan to the administrator of the datacenter network for approval. In one embodiment, upon receiving an approval (e.g., a reply message including the identifier of the plan) from the administrator, the planning module 222 may send the plan to a migration module 226 which may execute and/or monitor the migration of the one or more logical machines from one or more devices to one or more other devices of the datacenter network. In one embodiment, the migration module 226 may send relevant portions of the migration plan to devices that are involved in this migration of one or more logical machines in advance to allow the involved devices to schedule or reserve time to perform the migration. The relevant portion of the migration plan to an involved device may include, for example, which logical machine(s) will be migrated from and/or to the involved device, from and/or to which device(s) the logical machine(s) will be migrated, and/or a scheduled time of migrating the logical machine(s), etc.

In some embodiments, the migration module 226 may first send relevant portions of the migration plan to some devices that are involved in the migration, and then send other relevant portions of the migration plan to other devices involved in the migration when the former devices have completed or will complete their parts of service migration. In one embodiment, the migration module 226 may further monitor the progress of migration of the one or more logical machines and adjust a time of migration for a logical machine to be migrated if the progress of a currently migrating logical machine falls behind schedule or delayed, a device from or to which the logical machine to be migrated encounters a failure, etc.

In response to completing the migration of the one or more logical machines from one or more devices to one or more other devices of the datacenter network, the output module 224 may send a message to the administrator, notifying the administrator of the completion of the migration. The fault management system 102 or the input module 214 may wait for another instruction or request from the administrator of the datacenter network, and/or an administrator (or a system) associated with another datacenter network.

In some embodiments, the fault management system 102 may further include plan database 228 storing one or more plans that have been devised by the fault management system 102 (along with corresponding plan identifiers) for future reference or use. For example, the administrator of the datacenter network may need certain time to review the devised plan of migration sent by the fault management system 102, and may not respond to the fault management system immediately after receiving the devised plan. The plan database 228 allows the fault management system 102 to retrieve the devised plan based on corresponding plan identifier if an approval message from the administrator is later received by the fault management system 102.

### Exemplary Implementations

Exemplary implementations of the fault management system 102 are described as follows. These exemplary implementations are just some of the many implementations that can be derived based on the spirit of the present disclosure, and therefore should not be construed as limitations of the present disclosure. Furthermore, for simplicity, a datacenter network in these exemplary implementations is described to be a topology in form of a hierarchical structure, such as a tree structure. Moreover, in these exemplary implementations, only devices at the first two levels, namely at the root level and the second level of the hierarchical or tree structure are included in consideration. The present disclosure, however, does not limit a topology of a network to be a hierarchical structure. A network topology can include other structures, such as a star-like structure, a ring structure, a bus structure, a mesh structure, a daisy chain structure, a hybrid structure such as star-ring structure and a star-bus structure, or a combination thereof, etc. Furthermore, the present disclosure can be applied to management of part or all of the datacenter network, e.g., applying to all levels, a subset of all levels of the datacenter network, etc.

In these exemplary implementations, bandwidth at the core of the datacenter network is considered for illustrative purpose only. For example, average rates of data transmission at core links (i.e., links between devices at the root of the datacenter network and devices at the second level) are measured. A sum of these average rates may be used as an overall measure for the bandwidth at the core of the datacenter network, and is denoted as BW. Furthermore, for each service provided in the datacenter network, a worst-case survival (WCS) may be defined as the smallest fraction of devices that remain functional during a single failure in the datacenter network. For instance, if logical machines of a service are uniformly deployed across three groups or racks, and if only failures associated with TOR switches are considered, WCS is said to be two-thirds in this case. In one embodiment, an average WCS across services may be used as a measure for fault tolerance in the entire datacenter network, and may be denoted as FT. In some embodiments, the worst-case survival as defined herein is directly related to application-level metrics including, for example, throughput or capacity. For example, a service with WCS of 0.6 means losing at most 40% of its capacity during a single failure. Moreover, the number of logical machines that need to be moved and re-imaged in order to get from an initial distribution or allocation of logical machines to a proposed distribution or allocation of logical machines in the datacenter network may be denoted as NM.

In one embodiment, the fault management system 102 (or the input module 214) may receive information of a network topology of a datacenter network (or a plurality of clusters), services provided in the datacenter network and number of devices in which each service has been deployed (or number of devices required for each service), a list of fault domains in the datacenter network and a list of devices belonging to each fault domain, communication patterns (or a traffic matrix) for services provided in the datacenter network. In some embodiments, one or more of the above information may be determined and obtained by the analysis module 218 upon receiving information about the topology of the datacenter network and distribution of the services in the datacenter network.

In one embodiment, the fault management system 102 may model the datacenter as a hierarchical tree, each level of which may have a different oversubscription ratio, branching factor and redundancy count, for example. This model may represent a wide range of topologies from a Clos network/fat-tree (where the Clos network becomes a node with high branching factor, high redundancy count and low oversubscription) to a hub-and-spoke (high branching factor, redundancy count being one, and high oversubscription). Given a hierarchical tree representing the network topology of the datacenter network, core links are defined as links between the root of the tree and nodes at the second level of the tree.

Additionally or alternatively, based on the network topology and physical wiring of the clusters (or the datacenter network), the fault management system 102 may identify different types of fault domains. By way of example and not limitation, the fault management system 102 may identify, based on the network topology and physical wiring, fault domains related to server containers which may include a great number (e.g., a few thousands) of servers, top-of-rack switches, server enclosures each of which may include a few number (e.g., three or four) of servers, and power domains (e.g., power domains including hundreds of devices).

In one embodiment, the fault management system 102 may optimize distribution of the services (or logical machines of the services) in the datacenter network based on an objective function. By way of example and not limitation, if receiving an instruction or request to improve the fault tolerance and bandwidth usage of the datacenter network, the fault management system 102 may consider, for example, an optimization problem formulated as follows:

Maximize FT− α̅BW,

Subject to NM≦N₀ (1)

α̅ in Equation (1) is a tunable positive parameter, and N₀ is an upper limit on the number of moves. Equation (1) accommodates a flexible tradeoff between BW and FT, as manifested through a choice of α̅. Although Equation (1) is formulated as maximizing a function including fault tolerance and bandwidth, in some embodiments, other formulations such as minimizing NM under a constraint of certain improvements of BW and/or FT may be used. For the sake of description, the above formulation is used for illustration in these exemplary implementations.

By way of example and not limitation, assuming that the datacenter hosts or provides K number of services, with each service k needing or using sₖ devices. Furthermore, the devices in the datacenter network are subject to faults. Moreover, fault domains may or may not be overlapping with one another. In order to reduce complexity of the optimization problem, in one embodiment, the fault management system 102 may partition the devices in the datacenter network into cells, with each device belonging to a single cell. In one embodiment, a cell may include one or more devices that belong to same one or more fault domains, or in other words, the cells do not overlap with one another. Additionally, each device within a cell is indistinguishable from other devices within the same cell in terms of faults. In one embodiment, the fault management system 102 may describe an assignment of devices to each service using a set of variables {x_{n,k}}, where x_{n,k} represents how many devices within a cell n are allocated to a service k.

In one embodiment, if I(•,•) represents an indicator function, whose inputs are cell pairs, I(n₁,n₂)=1 if data traffic between n₁ and n₂ traverses through a core link, and I(n₁,n₂)=0 otherwise for each pair (n₁,n₂), the bandwidth BW, which is the total bandwidth consumption at the core in this example may be given as:

$$BW ( x ) = {\sum }_{{n}_{1} , {n}_{2}} {\sum }_{{k}_{1} , {k}_{2}} I ( {n}_{1} , {n}_{2} ) {x}_{{n}_{1} , {k}_{1}} {x}_{{n}_{2} , {k}_{2}} \frac{{R}_{{k}_{1} {k}_{2}}}{{s}_{{k}_{1} {s}_{{k}_{2}}}} \qquad ( 2 )$$

where Rₖ_{₁}_{,k}_{₂} is a bandwidth requirement or criterion between services k₁ and k₂, and E•,• sums each pair only once.

Additionally, if z_{k,j}(xₖ) [symbol] Θ_{nεj}x_{n,k} (i.e., the total number of devices allocated to a service k affected by fault j, where xₖ is a vector of allocations {x_{n,k}} for the service k), the fault tolerance FT in this example may be given as:

$$F T ( x ) = \frac{1}{K} {\sum }_{k = 1}^{K} \frac{{s}_{k} - {max}_{j} {z}_{k , j} ( {x}_{k} )}{{s}_{k}} \qquad ( 3 )$$

Given the above definitions of BW and FT, the fault management system 102 may solve the optimization problem as formulated in Equation (3). In some embodiments, the fault management system 102 may alternatively minimize a cost function to achieve optimization of fault tolerance, for example. By way of example and not limitation, the fault management system 102 may minimize a cost function, FTC, which is defined in this example as follows:

FTC(x)=ΣⱼwⱼΣₖbₖ(z_{k,j}(xₖ))² (4)

where z_{k,j} and xₖ are defined as above, and bₖ and wⱼ are positive weights that may be assigned to services and faults respectively.

In one embodiment, the fault management system 102 may assign a higher weight to a service of a smaller size (i.e., sₖ is smaller) as faults may have a relatively higher impact on that service. Additionally or alternatively, the fault management system 102 may use different weights for different services to prioritize service placement based on respective degrees of importance to the datacenter network and/or users of the datacenter network. In one embodiment, by using a convex objective function such as the cost function in Equation (4), “local” variable changes (e.g., swapping device allocation of two logical machines) that improve current value of the cost function further help to approach an optimal value for the cost function (as opposed to arbitrary cost functions, in which such moves will converge to a local minimum). In one embodiment, a decrease in FTC leads to an increase in FT, as squaring the z_{k,j} variables incentivizes keeping values of z_{k,j} to be small, which may be obtained, for example, by spreading the device assignment across multiple fault domains. In other words, FTC is negatively correlated with FT.

In one embodiment, the fault management system 102 may improve FTC by selecting one or more moves that maximally improve the current value of the cost function. In some embodiments, the fault management system 102 may employ device swaps, which may switch assignments of two devices while preserving the number of devices assigned to each service (where NM count is increased by two). In one embodiment, the fault management system 102 may select one or more swaps that maximally improve FTC, for example, in a sense of a greedy algorithm, and regard swaps as moves in a “steepest descent” direction. Due to the convexity characteristic of FTC, the fault management system 102 may iteratively improve FTC with greedy moves that reduce the current value of the cost function until, for example, reaching a global minimum (or substantially close to the global minimum) of the cost function.

By way of example and not limitation, the fault management system 102 may use an algorithmic approach that relies on designing algorithms individually optimizing either BW or FT. In one embodiment, the fault management system 102 may combine these algorithms into one or more “hybrid” algorithms that incorporate both objectives. For example, the fault management system 102 may optimize or minimize BW using a Multiple MinCut (also known as k-way min-cut) algorithm based on a communication graph of the services. The Multiple MinCut algorithm partitions the services into a plurality of clusters. Each of the plurality of clusters may correspond to a subset of the datacenter network that connects to the root of the datacenter network through core links. For example, each cluster may correspond to a VLAN (i.e., virtual local area network) and traffic between different VLANs passes through the core links.

In one embodiment, the fault management system 102 may construct a datacenter communication graph. Each node in the graph corresponds to a logical machine and a weight of each edge in the graph is set as an average traffic rate between the two logical machines. In one embodiment, the fault management system 102 may define a size of each cluster within each partition. Each cluster may or may not have the same size. In one embodiment, the fault management system 102 may determine which logical machines belong to which cluster while minimizing a total weight of the min-cut. The total weight is defined as BW, the bandwidth usage in the core under the suggested partitioning.

Based on the above construction, the fault management system 102 may consider a number of algorithms that are not constrained by the number of moves. In one embodiment, the fault management system 102 may divide each of these algorithms into two phases: the first phase related to minimizing BW, and the second phase related to minimizing FTC while penalizing swaps that increase the core bandwidth. By way of example and not limitation, a first algorithm, namely, CUT+FT algorithm, may include applying a CUT (i.e., Multiple MinCut as described above) in the first phase, and minimizing FTC in the second phase by swapping logical machines (or services).

Additionally or alternatively, the fault management system 102 may employ a second algorithm, which may be called CUT+FT+BW algorithm. The CUT+FT+BW algorithm may include applying a CUT as described in the CUT+FT algorithm, with a difference that a penalty term for the bandwidth may be added in the second phase. More specifically, the CUT+FT+BW algorithm may include a delta cost of a swap, i.e., ΔFTC+αΔBW, where α represents a weighting factor. In this CUT+FT+BW algorithm, the first phase may provide a low-bandwidth allocation, which is a starting allocation for the second phase. The second phase of the CUT+FT+BW algorithm aims at reducing FTC as much as possible while being aware of costly bandwidth moves. The weight α specifies a tradeoff between FT and BW. Since a steepest descent direction is chosen, the cost FTC+αBW is reduced using a relatively few number of moves, thus avoiding significant increase in bandwidth.

Additionally or alternatively, the fault management system 102 may employ a third algorithm, called CUT+RANDLOW. The CUT+RANDLOW algorithm may include applying a CUT in the first phase. In the second phase, the CUT+RANDLOW algorithm may determine a subset of services whose aggregate bandwidth requirements or criteria are lower than others, and randomly permute allocation of (physical) devices or logical machines for the services included in the subset. In one embodiment, the size of the subset may be included as an adjustable parameter of the CUT+RANDLOW algorithm. This CUT+RANDLOW algorithm takes an advantage of having logical machines that do not consume much bandwidth. Consequently, even random “spreading” of these logical machines may lead to significant improvements in FT without significantly affecting the bandwidth consumption. These three algorithms may be used for initial allocation of logical machines in a datacenter network.

Additionally or alternatively, the fault management system 102 may employ a fourth algorithm, namely, FT+BW algorithm. The FT+BW algorithm takes an initial allocation of logical machines of a datacenter network as an input, and perform the second phase of the CUT+FT+BW algorithm described above.

Additionally or alternatively, in some embodiments, the fault management system 102 may sample a number of candidate swaps (instead of exploring all possible swaps), and select one or more of the candidate swaps that maximally improve FTC. Due to a separable structure of FTC, the fault management system 102 may compute an improvement in FTC incrementally and efficiently, allowing a large number of swaps to be examined. Additionally or alternatively, when performing a graph cut on the datacenter communication graph, the fault management system 102 may employ a coarsening approach in which logical machines of a same service may be grouped together into a smaller number of representative nodes. Accordingly, an edge weight between each pair of such nodes may become a sum of inter-traffic rates between the logical machines of respective pair. Additionally or alternatively, the fault management system 102 may explore the skewness of communication patterns (or traffic) associated with the services in the datacenter network as described in the foregoing embodiments.

In one embodiment, upon determining which one or more logical machines to be migrated for improving the fault tolerance and bandwidth usage of the datacenter network, the fault management system 102 may devise and send a plan of migration for these one or more logical machines to the administrator of the datacenter network for approval as described in the foregoing embodiments. Upon receiving an approval from the administrator, the fault management system 102 may start coordinating the migration according to the devised or approved plan.

### Alternative Embodiments

In one embodiment, the fault management system 102 or the determination module 220 may further take hard constraints on fault tolerance, placement and swap of logical machines into consideration when determining which one or more logical machines to be migrated. For example, certain services may have hard constraints on a minimum worst-case survival and/or configuration (such as memory size, processor speed, etc.) of devices in which the services may be run. When determining to which device(s) a selected logical machine of a service may be migrated, the determination module 220 may further determine whether a hard constraint associated with the service is fulfilled in a device that is proposed to receive the selected logical machine. If not, the determination module 220 may determine another device to which the logical machine may be migrated, for example, by selecting a device that is second to the proposed device in optimizing an objective or cost function based on an optimization algorithm. Alternatively, in some embodiments, the determination module 220 may select another logical machine that is second the originally selected logical machine in optimizing an objective or cost function based on an optimization algorithm (e.g., a greedy algorithm).

Furthermore, in some embodiments, the fault management system 102 or the analysis module 218 may analyze the communication patterns of the services of the datacenter network, and further determine which one or more services are locality-aware services, i.e., services that communicate more frequently with other services or devices that are closer thereto than services or devices that are farther thereto. The fault management system 102 or the determination module 220 may take these locality-aware services into consideration when determining which one or more logical machines of the services to be migrated. For example, the determination module 220 may determine not to migrate a logical machines of a locality-aware service to a device far away from a device in which the logical machines of the locality-aware service is deployed unless an increase in fault tolerance compensates a cost due to an increase in bandwidth usage. In some embodiments, the determination module 220 may determine that the logical machine of the locality-aware service, if determined to be migrated, may be migrated to a device that is near to the device in which the logical machine of the locality-aware service is previously or originally deployed. This may therefore improve fault tolerance of the datacenter network without significantly increasing bandwidth usage associated with the datacenter network. Additionally or alternatively, the determination module 220 may determine that the logical machine of the locality-aware service, if determined to be migrated, may be migrated to a device (or another service or a logical machine of the other service) with which the logical machines of the locality-aware service communicates most frequently. Thus, fault tolerance of the service and possibly bandwidth usage associated with the datacenter network can be improved simultaneously. Additionally or alternatively, the device to which the logical machine of the locality-aware service may be migrated may belong to a fault domain different from a fault domain of the device in which the logical machine of the locality-aware service is deployed, thus improving the fault tolerance of the datacenter network.

### Exemplary Methods

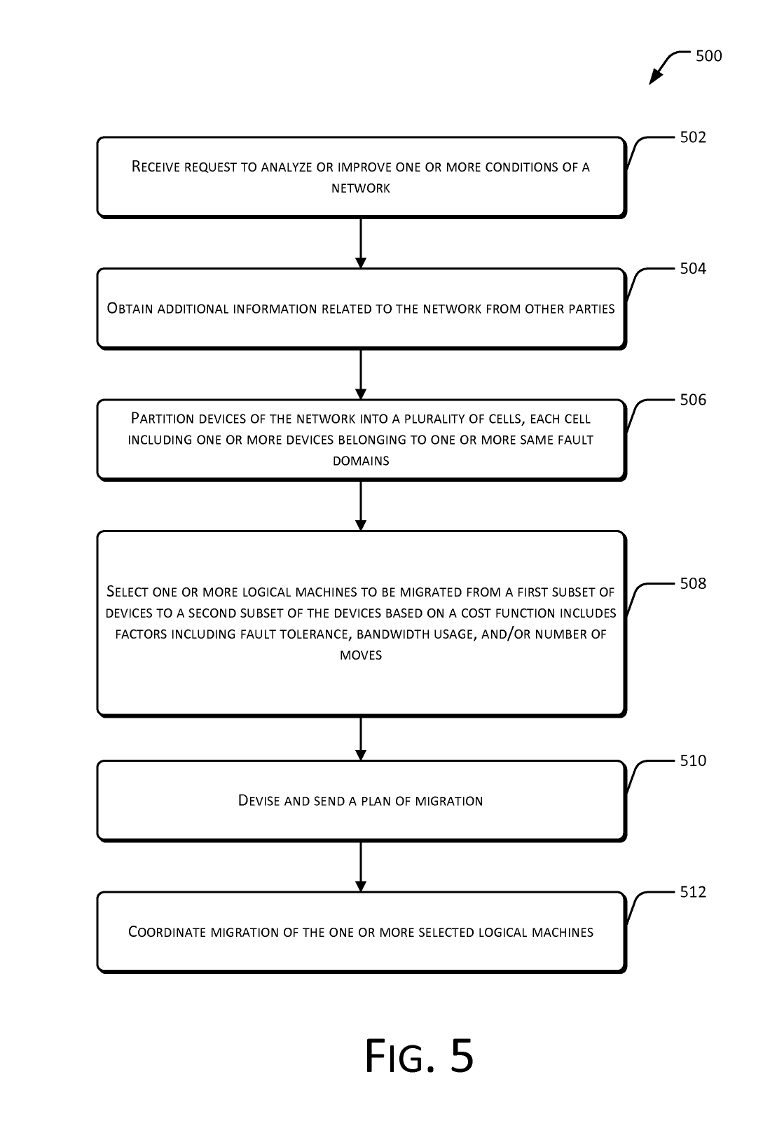

FIG. 5 is a flow chart depicting an example method 500 of improving one or more conditions of a network of devices. The method of FIG. 5 may, but need not, be implemented in the environment of FIG. 1 and using the system of FIG. 2. For ease of explanation, method 500 is described with reference to FIGS. 1 and 2. However, the method 500 may alternatively be implemented in other environments and/or using other systems.

Method 500 is described in the general context of computer-executable instructions. Generally, computer-executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer-executable instructions may be located in local and/or remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 5, at block 502, the fault management system 102 may receive an instruction or request from personnel (such as an administrator) of a datacenter network. The instruction or request may include a request to analyze the datacenter network and/or improve one or more conditions (e.g., fault tolerance, bandwidth usage, response time latency, etc.) in the datacenter network. The instruction or request may further include information about the datacenter network, such a topology of the datacenter network, the number of devices in the network, the number of services provided in the network, in which device each logical machine of a service is deployed, communication patterns or traffic among the services and/or logical machines of the services, etc.

At block 504, in response to receiving the instruction or request, the fault management system 102 may further obtain additional information associated with datacenter network from, for example, one or more devices of the datacenter network, a third-party server that may or may not be affiliated with the datacenter network, etc., that is not included in the instruction or request. For example, the instruction or request may include an identifier of the datacenter network without providing any information about the topology of the datacenter network, etc. The fault management system 102 may then obtain relevant information about the datacenter network based on the identifier of the datacenter network.

At block 506, the fault management system 102 may analyze the topology of the datacenter network and distribution of the services in the datacenter network. In one embodiment, the fault management system 102 may reduce the complexity of determination of service migration by dividing or partitioning the devices in the datacenter network into a plurality of cells or groups, thus reducing the number of entities to be considered. In one embodiment, each cell or group may include one or more devices that belong to one or more same fault domains and are indistinguishable from each other in terms of faults associated with the one or more same fault domains.

At block 508, the fault management system 102 may employ an optimization algorithm to select one or more logical machines (or logical machines within one or more cells) to be migrated based on an objective or cost function. In one embodiment, the objective or cost function may include factors associated with fault tolerance, bandwidth usage, response time latency, number of moves of services, amount of data transfer, etc. For example, the fault management system 102 may select one or more logical machines that, when migrated, would improve fault tolerance and/or bandwidth usage of one or more services provided and/or supported by the one or more logical machines in the datacenter network. Specifically, the fault management system 102 may select one or more logical machines to be migrated or moved from a first state in which the one or more logical machines are originally hosted on a first subset of the plurality of devices of the datacenter network to a second state in which the one or more services are to be hosted on a second subset of the plurality of devices of the datacenter network in order to, for example, reduce the bandwidth usage and increase the fault tolerance associated with the datacenter network.

By way of example and not limitation, in one embodiment, the fault management system 102 may select a number of logical machines as candidate logical machines for consideration in service migration based on a predetermined strategy. In one embodiment, the predetermined strategy may include, for example, randomly selecting a number of logical machines from the datacenter network, selecting a number of logical machines that are located in one or more particular fault domains or geographical locations, and/or selecting a number of logical machines that provide and/or support functions for one or more particular services in the datacenter network, etc. In response to selecting candidate logical machines for consideration in service migration, in one embodiment, the fault management system 102 may determine or select one or more logical machines from these candidate logical machines that may optimize the objective or cost function as described above. For example, the fault management system 102 may select one or more logical machines from the candidate logical machines that return the first few (or a predetermined number) lowest values of the objective or cost function.

In some embodiments, the fault management system 102 may select the one or more logical machines to be migrated based on detecting skewness of the communication patterns or traffic among the services provided in the datacenter network. Additionally or alternatively, the fault management system 102 may select the one or more logical machines to be migrated based on amount of data transfer needed for the migration. For example, the fault management system 102 may select the one or more logical machines that would minimize an amount of data transfer to accomplish the migration while improving the fault tolerance and/or the bandwidth usage of one or more services in the network.

At block 510, in response to determining which one or more logical machines to be migrated, the fault management system 102 may devise a plan of migration and send the plan of migration to the personnel of the datacenter network for approval.

At block 512, upon receiving an approval from the personnel of the datacenter network, the fault management system 102 may supervise or coordinate migration of the one or more selected logical machines from one or more devices to one or more other devices of the datacenter network. Specifically, the fault management system 102 may migrate the one or more selected logical machines from the first state in which the one or more selected logical machines are originally hosted on the first subset of the plurality of devices of the datacenter network to the second state in which the one or more selected logical machines are to be hosted on the second subset of the plurality of devices of the datacenter network, in order to improve the bandwidth usage and/or the fault tolerance associated with the datacenter network. The fault management system 102 may send a notification to the personnel of the datacenter network upon successful migration of the one or more selected logical machines.

Although the above acts are described to be performed by the fault management system 102, one or more acts that are performed by the fault management system 102 may be performed by the device 106 or other software or hardware of the device 106 and/or any other computing device (e.g., the server 108), and vice versa. For example, one or more devices 106 and/or the server 108 may include analyzing communication patterns of the datacenter network. The one or more devices 106 and/or the server 108 may then send an analysis result to the fault management system 102 for fault management.

Furthermore, one or more devices 106, the server 108, and the fault management system 102 may cooperate to complete an act that is described to be performed by the fault management system 102. For example, a device 106 may suggest one or more logical machines deployed therein to migrate from that device 106 to the fault management system 102 through the network 104. The device 106 may note that the one or more suggested logical machines are involved in communications with logical machines in other devices frequently or intensively (in a sense of data traffic, for example). The fault management system 102 may receive the suggestion from the device 106 may analyze a communication pattern (or part of the communication pattern associated with that device 106 or the one or more suggested logical machines), and determine whether the one or more suggested logical machines need to be migrated and if migrated, to where the one or more suggested logical machines may be migrated. The fault management system 102 may send a plan of migration to the server 108 which may coordinate the migration of the one or more suggested logical machines from that device 106 to other devices so that the fault management system 102 may continue to listen to instructions or requests from other devices 106.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media such as one or more computer storage media.

### CONCLUSION

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A system comprising:
one or more processors;
memory, communicatively coupled to the one or more processors, storing instructions that, when executed by the one or more processors, configure the one or more processors to perform acts comprising:
dividing a network of devices into a plurality of cells, each cell comprising one or more devices of the network that belong to a same fault domain and are indistinguishable from each other in view of a fault associated with the same fault domain, wherein each cell further comprises one or more logical machines deployed in the one or more devices; and
determining a logical machine to be migrated from a first subset of the plurality of cells to a second subset of the plurality of cells based on a cost function, the cost function comprising a first factor for fault tolerance associated with at least one service supported by the logical machine and a second factor for bandwidth usage associated with the at least one service.

2. The system as recited in claim 1, wherein the determining comprises:
selecting a plurality of logical machines from the network of devices according to a predetermined strategy, the plurality of logical machines being a subset less than all of logical machines included in the network of devices;
deciding the logical machine to be migrated from the plurality of selected logical machines based on the cost function.

3. The system as recited in claim 2, wherein the predetermined strategy comprises:
randomly selecting the plurality of logical machines from the network of devices;
selecting the plurality of logical machines that are located in one or more particular fault domains; and/or
selecting the plurality of logical machines that provide support for one or more particular services in the network of devices.

4. The system as recited in claim 2, wherein the deciding comprises:
finding a logical machine that minimizes the cost function among the plurality of logical machines; and
rendering the found logical machine to be the determined logical machine to be migrated.

5. The system as recited in claim 1, further comprising receiving an event for triggering determination of migration of the logical machine, the event comprising an indication of a time scheduled for the determination, a deployment of a new service, and/or a change in communication patterns associated with a plurality of logical machines deployed in the network of devices.

6. The system as recited in claim 1, wherein the cost function further comprises a third factor for a maximally allowed number of moves of logical machines.

7. The system as recited in claim 1, further comprising migrating the determined logical machine from the first subset of the plurality of cells to the second subset of the plurality of cells.

8. The system as recited in claim 1, further comprising receiving information of the network of devices, the information comprising communication patterns associated with a plurality of logical machines included in the network of devices.

9. The system as recited in claim 1, wherein the same fault domain of each cell comprises a server container, a top-of-rack switch, a server enclosure, and/or a power domain.

10. A method comprising:
under control of one or more processors configured with executable instructions:
receiving information associated with a network of devices comprising a plurality of logical machines that support a plurality of services, the received information comprising information associated with communication patterns of at least some of the plurality of logical machines; and
determining one or more logical machines to be moved from a first subset of the devices to a second subset of the devices based on the received information and a cost function comprising a plurality of factors, the plurality of factors comprising at least two of fault tolerance associated with services supported by the at least some of the plurality of logical machines, bandwidth usage associated with the at least some of the plurality of logical machines, and a maximally allowed number of moves of logical machines.

11. The method as recited in claim 10, wherein the determining comprising:
determining one or more swaps of logical machines that minimize the cost function based on an optimization algorithm; and
rendering the logical machines associated with the one or more swaps that minimize the cost function to be the one or more logical machines to be moved.

12. The method as recited in claim 11, wherein determining the one or more swaps is performed based on an application of a greedy algorithm on the cost function.

13. The method as recited in claim 10, further comprising selecting a subset of the plurality of logical machines based on a predetermined strategy, wherein the determining comprises determining the one or more logical machines from the subset of the plurality of logical machines.

14. The method as recited in claim 13, wherein the predetermined strategy comprises:
randomly selecting the subset from the plurality of logical machines;
selecting the subset of the plurality of logical machines that are located in one or more fault domains; and/or
selecting the subset of the plurality of logical machines that provide support for one or more particular services in the network of devices.

15. The method as recited in claim 10, further comprising dividing the plurality of logical machines into a plurality of cells, each cell comprising one or more devices of the network that belong to a same fault domain and are indistinguishable from each other in view of a fault associated with the same fault domain, wherein each cell further comprises one or more logical machines deployed in the one or more devices.

16. The method as recited in claim 10, further comprising receiving an event for triggering determination of migration of the one or more logical machines, the event comprising an indication of a time scheduled for the determination, a deployment of a new service, and/or a change in communication patterns associated with the plurality of logical machines deployed in the network of devices.

17. One or more computer-readable media storing executable instructions that, when executed by one or more processors, configure the one or more processors to perform acts comprising:
receiving information of a topology of a network of devices, the devices including a plurality of logical machines;
determining one or more logical machines of the plurality of logical machines that, if migrated from a first subset of the devices to a second subset of the devices, would cause a reduction in a cost function comprising a first factor for bandwidth usage associated with at least some of the plurality of logical machines and a second factor for fault tolerance of the at least some of the plurality of logical machines.

18. The one or more computer-readable media as recited in claim 17, the acts further comprising migrating the one or more logical machines from the first subset of the devices to the second subset of the devices.

19. The one or more computer-readable media as recited in claim 17, wherein the determining comprises randomly selecting a subset of the plurality of logical machines, the subset being less than all of the plurality of logical machines.

20. The one or more computer-readable media as recited in claim 19, wherein the determining further comprises:
determining one or more swaps of logical machines that minimize the cost function based on an optimization algorithm, the logical machines of the one or more swaps being selected from the randomly selected subset of the plurality of logical machines; and
rendering the logical machines of the one or more swaps to be the one or more logical machines to be migrated.
